(19) United States
(12) Patent Application Publication
(10) Pub. No.: US 2017/0118921 A1
(43) Pub. Date: May 4, 2017

(54) TREE PRUNER

(71) Applicant: Yu-Sheng LO, Taichung City (TW)

(72) Inventor: Yu-Sheng LO, Taichung City (TW)

(21) Appl. No.: 14/925,342

(22) Filed: Oct. 28, 2015

(51) Int. Cl. A01G 3/025

(52) U.S. Cl. CPC A01G 3/0255

(57) ABSTRACT

A tree pruner includes an extension shaft, a fixed jaw secured on a top of the extension shaft, a blade laterally and pivotally mounted onto the fixed jaw, an operating element connected to the extension shaft for operating the blade and a clamping device laterally secured on the fixed jaw. The fixed jaw and the blade are coupled to cut the branch and the clamping device is provided to clamp the cut branch.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a tree pruner, and more particularly to a tree pruner that has an improved cutting range.

2. Description of Related Art Including Information Disclosed Under 37 CFR 1.97 and 37 CFR 1.98.

The cut branch falls directly to the ground when using a conventional tree pruner to cut the branch such that the conventional tree pruner is unsuitable for harvesting fruits such that an altered tree pruner is marketed.

The altered conventional tree pruner includes an upper clamp secured on a back of a chopping board of a fixed jaw and a lower clamp secured on a back of a cutting edge of a blade. The lower clamp is moved toward the upper clamp for clamping the cut branch with the harvested fruit to prevent the fruit from directly falling to the ground and improve the quality of the harvested fruit.

The altered conventional tree pruner is widely used for cutting branches or harvesting fruit. However, the axis of the blade is parallel to that of the hand-held extension rod when the blade of the altered conventional tree most widely opened blade such that the angle between the opened blade and the fixed jaw is limited and the cutting range of the branch is seriously limited.

The present invention has arisen to mitigate and/or obviate the disadvantages of the conventional tree pruners.

### BRIEF SUMMARY OF THE INVENTION

The main objective of the present invention is to provide an improved tree pruner that has an improved cutting range.

To achieve the objective, the tree pruner in accordance with the present invention comprises an extension shaft, a fixed jaw secured on a top of the extension shaft, a blade laterally and pivotally mounted onto the fixed jaw, an operating device connected to the extension shaft for operating the blade and a clamping device laterally secured on the fixed jaw. The fixed jaw and the blade are coupled to cut the branch and the clamping device is provided to clamp the cut branch. The fixed jaw includes a main plate and a curved chopping board extending from the main plate, wherein the blade is laterally pivotally mounted onto the main plate by a pivot. The blade is formed with a cutting edge and an extension portion extending therefrom. The cutting edge is downward oscillated relative to the chopping board to allow the branch moved into the position between the cutting edge and the chopping board. The cutting edge is moved toward the chopping board to cut the branch between the cutting edge and the chopping board. The operating device is provided to operate the extension portion of the blade. The clamping device includes a first clamp secured on a back of the chopping board and a second clamp secured on a back of the cutting edge of the blade such that the second clamp is moved toward the first clamp during cutting the branch. The extension line of a rear edge of the cutting edge and the datum line of the extension shaft form an angle when the cutting edge of the blade is downward oscillated and the rear edge of the cutting edge is moved over the datum line of the extension shaft. Consequently, an angle is formed between the cutting edge and the chopping board of the fixed jaw is expanded for promoting the cutting range of the tree pruner.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is a perspective view of a tree pruner in accordance with the present invention.

FIG. 2 is a another perspective view of the tree pruner in accordance with the present invention.

FIG. 3 is a side plan view of the tree pruner as shown in FIG. 1/FIG. 2.

FIG. 4 is an operational view of the tree pruner in accordance with the present invention before cutting the branch.

FIG. 5 is an operational view of the tree pruner in accordance with the present invention after cutting the branch.

FIG. 6 is a side plan view of a second embodiment of the tree pruner in accordance with the present invention.

### DETAILED DESCRIPTION OF THE INVENTION

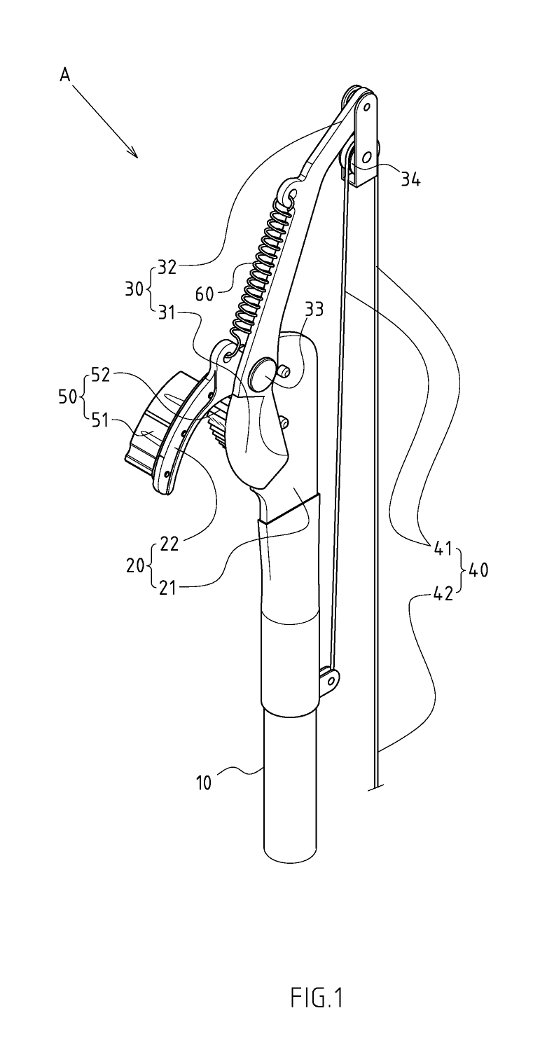

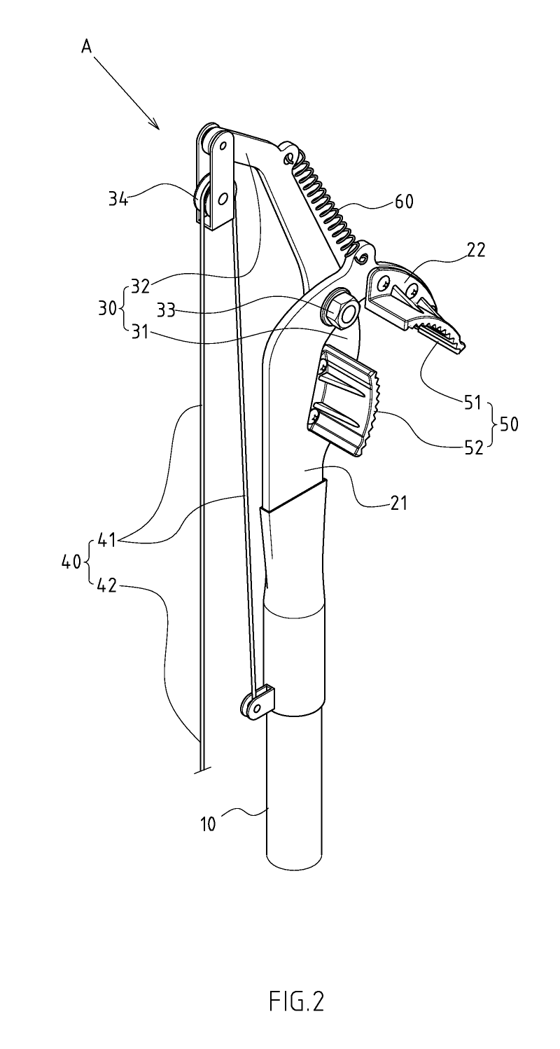

Referring to the drawings and initially to FIGS. 1-3, a tree pruner A in accordance with the present invention comprises an extension shaft 10, a fixed jaw 20 secured on a top of the extension shaft 10, a blade 30 laterally and pivotally mounted onto the fixed jaw 20, an operating device 40 connected to the extension shaft 10 for operating the blade and a clamping device 50 laterally secured on the fixed jaw 20. The fixed jaw 20 and the blade 30 are coupled to cut the branch and the clamping device 50 is provided to clamp the cut branch.

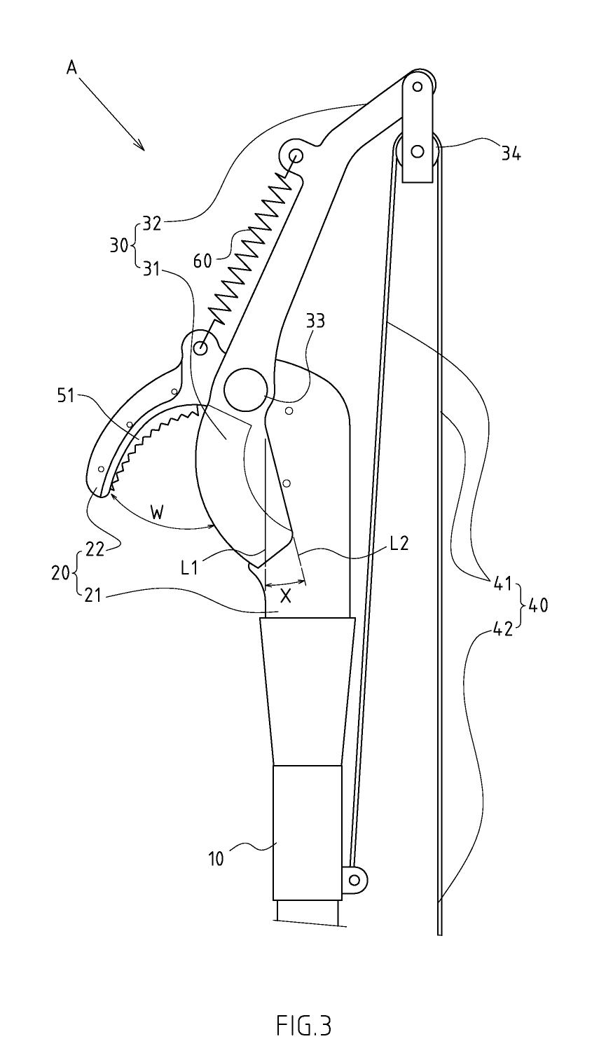

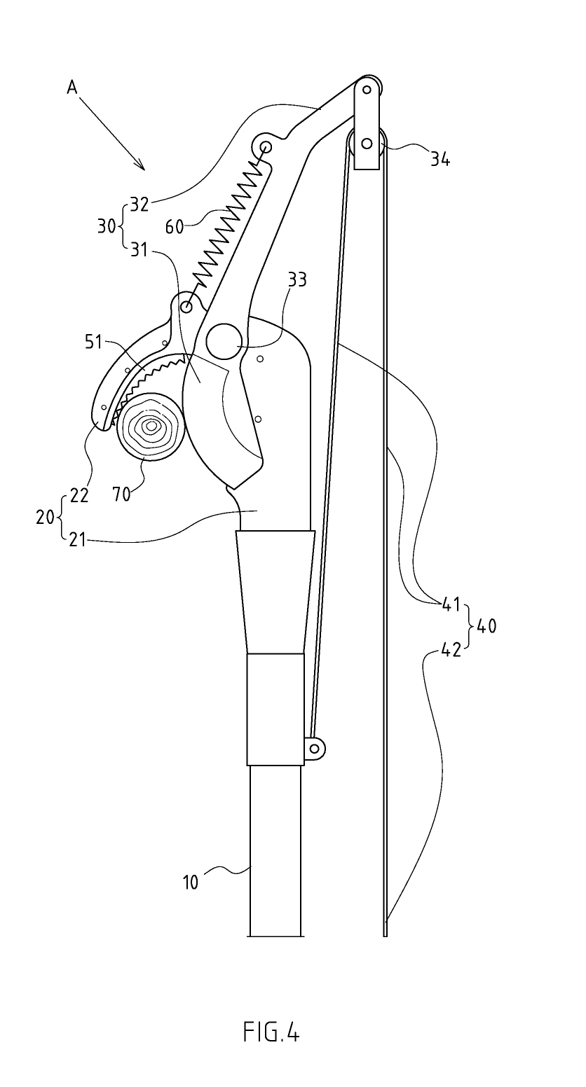

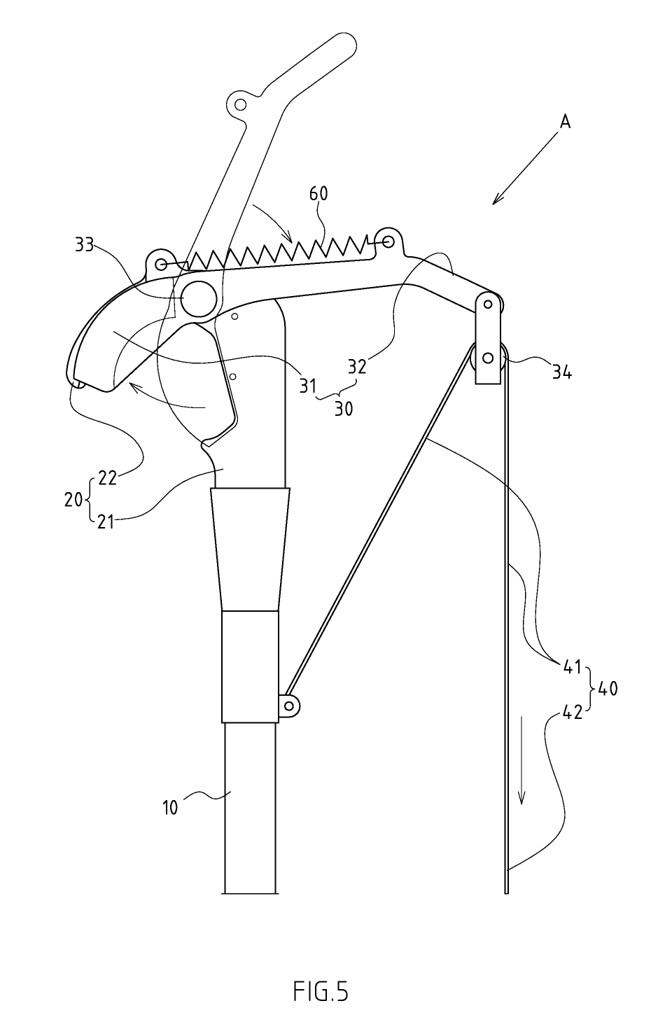

The fixed jaw 20 includes a main plate 21 and a curved chopping board 22 extending from the main plate 21, wherein the blade 30 is laterally pivotally mounted onto the main plate 21 by a pivot 31. The blade 30 is formed with a cutting edge 31 and an extension portion 32 extending therefrom. With reference to FIGS. 3 and 4, the cutting edge 31 is downward oscillated relative to the chopping board 22 to allow the branch 70 moved into the position between the cutting edge 31 and the chopping board 22. With reference to FIG. 5, the cutting edge 31 is moved toward the chopping board 22 to cut the branch between the cutting edge 31 and the chopping board 22. The operating device 40 is provided to operate the extension portion 32 of the blade 30. The clamping device 50 includes a first clamp 51 secured on a back of the chopping board 22 and a second clamp 52 secured on a back of the cutting edge 31 of the blade 30 such that the second clamp 52 is moved toward the first clamp 51 during cutting the branch 70. With reference to FIG. 3, the extension line L2 of a rear edge of the cutting edge 31 and the datum line L1 of the extension shaft 10 form an angle X when the cutting edge 31 of the blade 30 is downward oscillated and the rear edge of the cutting edge 31 is moved over the datum line L1 of the extension shaft 10. Consequently, an angle W is formed between the cutting edge 31 and the chopping board 22 of the fixed jaw 20 is expanded for promoting the cutting range of the tree pruner A.

As described above, the angle X formed by the extension line L2 of a rear edge of the cutting edge 31 and the datum line L1 of the extension shaft 10 is set up from ten to twenty degrees. In the preferred embodiment of the present invention, the angle X formed by the extension line L2 of a rear edge of the cutting edge 31 and the datum line L1 of the extension shaft 10 is fifteen degrees.

With reference to FIGS. 1 to 3, the operating device 40 is a rope and divided into an operating portion 41 and a pulling portion 42, wherein the operating portion 41 is provided to operate the extension portion 32 of the blade 30 and the pulling portion 42 downward extends for operator to hold and pull. A pulley 34 is disposed on a free end of the extension portion 32 of the blade 30 and the operating portion 41 of the operating device 40 coils the pulley for changing the extending direction of the operating device (rope) 40. The tree pruner A in accordance with the present invention further comprises a spring 60 includes two opposite ends respectively connected to the extension portion 32 of the blade 30 and the fixed jaw 20 for providing a restitution force to the blade 30 after cutting the branch 70.

With reference to FIG. 3, the extension line L2 of a rear edge of the cutting edge 31 and the datum line L1 of the extension shaft 10 form an angle X when the cutting edge 31 of the blade 30 is downward oscillated and the rear edge of the cutting edge 31 is moved over the datum line L1 of the extension shaft 10. Consequently, an angle W formed between the cutting edge 31 and the chopping board 22 of the fixed jaw 20 is expanded and the cutting range of the tree pruner A is improved. With reference to FIG. 4, when using the tree pruner A to cut branch 70, the cutting edge 31 of the blade 30 is downward oscillated and bites the branch 70 with the first clamp 51 due to the restitution force from the spring 60. With reference to FIG. 5, the cutting edge 31 of the blade 30 is upwardly oscillated and the pivot 33 is used as an axle when the operating device 40 is downward pulled. The branch 70 is cut off and clamped between the first clamp 51 and the second clamp 52 when the cutting edge 31 moved over an edge of the chopping board 22. The cutting edge 31 of the blade 30 in move to the original position and the clamping device 50 releases the cut branch 70 due to the restitution force of the spring 60 when the operator releases the pulling portion 42 of the operating device 40.

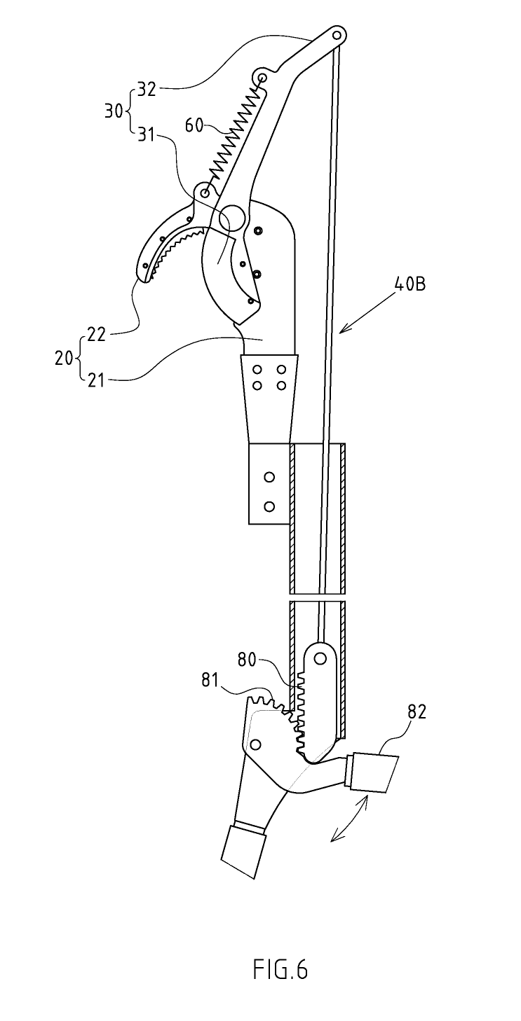

With reference to FIG. 6 that shows a second embodiment of the operating device 40B in accordance with the present invention, in this embodiment, the operating device 40B further comprises a straight rack 80 movably received in the extension shaft 10 and a lever 82 pivotally mounted onto the extension shaft 10, wherein the lever 82 is formed with a curved rack 81 engaged to the straight rack 80 such that the operating device 40B is pulled when the lever 80 is downward wrenched.

As described above, the extension line L2 of a rear edge of the cutting edge 31 and the datum line L1 of the extension shaft 10 form an angle X when the cutting edge 31 of the blade 30 is downward oscillated and the rear edge of the cutting edge 31 is moved over the datum line L1 of the extension shaft 10. Consequently, an angle W formed between the cutting edge 31 and the chopping board 22 of the fixed jaw 20 is expanded for promoting the cutting range of the branch 70.

Although the invention has been explained in relation to its preferred embodiment, it is to be understood that many other possible modifications and variations can be made without departing from the spirit and scope of the invention as hereinafter claimed.

I claim:

1. A tree pruner comprising an extension shaft, a fixed jaw secured on a top of the extension shaft, a blade laterally and pivotally mounted onto the fixed jaw, an operating device connected to the extension shaft for operating the blade and a clamping device laterally secured on the fixed jaw, wherein the fixed jaw and the blade are coupled to cut the branch and the clamping device is provided to clamp the cut branch; the fixed jaw including a main plate and a curved chopping board extending from the main plate, wherein the blade is laterally pivotally mounted onto the main plate by a pivot, the blade formed with a cutting edge and an extension portion extending therefrom, wherein the cutting edge is downward oscillated relative to the chopping board to allow the branch moved into the position between the cutting edge and the chopping board, and the cutting edge is moved toward the chopping board to cut the branch between the cutting edge and the chopping board, the operating device provided to operate the extension portion of the blade, the clamping device including a first clamp secured on a back of the chopping board and a second clamp secured on a back of the cutting edge of the blade such that the second clamp is moved toward the first clamp during cutting the branch; an extension line of a rear edge of the cutting edge and a datum line of the extension shaft forming an angle when the cutting edge of the blade is downward oscillated and the rear edge of the cutting edge is moved over the datum line of the extension shaft such that an angle is formed between the cutting edge and the chopping board of the fixed jaw is expanded for promoting the cutting range of the tree pruner.

2. The tree pruner as claimed in claim 1, wherein the angle formed by the extension line of a rear edge of the cutting edge and the datum line of the extension shaft is set up from ten to twenty degrees.

3. The tree pruner as claimed in claim 2, wherein the angle formed by the extension line of a rear edge of the cutting edge and the datum line of the extension shaft is fifteen degrees.

4. The tree pruner as claimed in claim 2, wherein the operating device is a rope and divided into an operating portion and a pulling portion, the operating portion provided to operate the extension portion of the blade and the pulling portion downward extending for operator to hold and pull, a pulley disposed on a free end of the extension portion of the blade and the operating portion of the operating device coiling the pulley for changing the extending direction of the operating device; a spring including two opposite ends respectively connected to the extension portion of the blade and the fixed jaw for providing a restitution force to the blade after cutting the branch.

5. The tree pruner as claimed in claim 3, wherein the operating device is a rope and divided into an operating portion and a pulling portion, the operating portion provided to operate the extension portion of the blade and the pulling portion downward extending for operator to hold and pull, a pulley disposed on a free end of the extension portion of the blade and the operating portion of the operating device coiling the pulley for changing the extending direction of the operating device; a spring including two opposite ends respectively connected to the extension portion of the blade and the fixed jaw for providing a restitution force to the blade after cutting the branch.
